(19) United States
(12) Patent Application Publication
(10) Pub. No.: US 2019/0228325 A1
(43) Pub. Date: Jul. 25, 2019

(54) SMART DATA CORRELATION GUESSER: SYSTEM AND METHOD FOR INFERENCING CORRELATION BETWEEN DATA STREAMS AND CONNECTING DATA STREAMS

(71) Applicant: HEXANIKA, New York, NY (US)

(72) Inventors: Makarand Gadre, Seattle, WA (US); Yogesh Pandit, Haledon, NY (US)

(21) Appl. No.: 16/330,052

(22) PCT Filed: Aug. 2, 2017
(86) PCT No.: PCT/US17/45131

§ 371 Date: Mar. 1, 2019

Related U.S. Application Data
(60) Provisional application No. 62/370,059, filed on Aug. 2, 2016.

(51) Int. Cl. G06N 5/04; G06F 16/25; G06F 16/22

(52) U.S. Cl. CPC G06N 5/04; G06F 16/22; G06F 16/258

(57) ABSTRACT

Methods and System for collecting, consolidating and processing data are provided. The method includes creating a multi-tenant cloud service, wherein a plurality of users from multiple organizations are capable of submitting data via one or multiple physical and/or ephemeral data streams to the multi-tenant cloud service, the multi-tenant cloud service processes the data independently and/or in an aggregated formats, implementing an ingress system, the ingress system capable of allowing the users to submit the data in various formats, providing correlation inferences based in the user inputs, creating an ingress point where the user can specify previously known correlation patterns, and allowing users to retrieve the results of the correlation inference.

### FIELD

The present disclosure provides a system and method for predicting correlations between multiple data streams, and connecting & consolidating multiple data streams, and more particularly, to a system and method for predicting correlation between multiple data streams, connecting, and creating a full or partial data matching between various fields in data streams for further analysis, reporting, machine learning, trend analysis, and general data consumption.

### BACKGROUND

Data is produced at various points of origin during business processes. With the declining costs data storage, and increasing availability computing power, and of networked computers both in the internal networks and internet. With computers and devices acquiring and producing data with or without human participation multiple voluminous data streams are produced every instant. Businesses are interested in collaborating the data streams for further analysis. Such collaborated, correlated data streams are used for various business processes like reporting, trend analysis predictive analysis, etc. The data origination points produce data in formats native to the data origination points and with the possibly limited information available at the point of origination. The volume of the data can to be huge, in the multi-terabyte range, however the volume of data is not limited thereto. Typically, the data is brought at one place for further processing. The data that is generated pertains to millions of transactions or events captured at various data origination and collection points. The data includes a plurality of data sources belonging to a plurality of data formats that need to be correlated and integrated in a globalized environment. The data can have unnecessary duplicated information which consumes resources and processing power.

Therefore, there is a need for a system and method for inspecting various data stream and formulating the qualification criteria for correlating, connecting, and data consolidating. This may be done manually by subject matter experts and data engineers who inspect data and formulate the qualification criteria or may be done by coding into the systems. This is an activity where human errors can hamper the formulation of qualification criteria. Such errors have can render the data correlation irrelevant, or subtle correlations can be overlooked.

### SUMMARY

The system includes a Client Task Orchestrator (101). Further, the system includes a User Authentication and Role Provider (102) to authenticate the user identity. The system includes an Ingress Service Module (103) where a user can specify data streams/data files to be processed by Smart Data Correlation Guesser. The user can specify to the Client Task Orchestrator (101), to run the Guesser Service job or request the output from an earlier completed job. The system also includes a Correlation Qualification Criteria Acceptance Service Module (106), for the user to specify previously known Correlation Qualification Criteria. The Smart Join Guesser includes a Data Reader module (104) which is used to retrieve the data to be processed. The Data Reader Module (104) stores the data in a Local Transient Data storage (105) for processing. The system further includes Correlation Inference Engine service module (108) which reads the data from the data streams and attempts to identify qualification criteria to be able to correlate data elements from multiple data streams. The system also includes a Reference Database (107) which has commonly used information like Month Names in various languages, ISO codes for countries, ISO codes for currencies etc.

Accordingly, the present disclosure provides a system and method for inferring and formulating correlation qualification criteria between the various data streams. The method includes creating a multi-tenant cloud service, wherein a plurality of users from multiple organizations are capable of submitting and specifying data streams via one or multiple physical and/or ephemeral data streams to the multi-tenant cloud service. The use and benefits, however, are not limited to the multi-tenant cloud service, and can be used with an on-premise service as well. The multi-tenant cloud service and processes the data independently and independently and/or in an aggregated formats and securely.

According to an aspect of an exemplary embodiment, a method for collecting, consolidating and processing data includes creating a multi-tenant cloud service, wherein a plurality of users from multiple organizations are capable of submitting data via one or multiple physical and/or ephemeral data streams to the multi-tenant cloud service, the multi-tenant cloud service processes the data independently and/or in an aggregated formats, implementing an ingress system, the ingress system capable of allowing the users to submit the data in various formats, providing correlation inferences based in the user inputs, creating an ingress point where the user can specify previously known correlation patterns, and allowing users to retrieve the results of the correlation inference.

According to another exemplary embodiment, the plurality of users are capable of being uploading and processing data in the multi-tenant cloud service independently.

According to another exemplary embodiment, the data can be submitted using various data formats, persisted and/r ephemeral.

According to another exemplary embodiment, all organizations are being capable of uploading data using more than one format.

According to an aspect of an exemplary embodiment, a system for collecting, consolidating and processing data includes a database service that is programmed and configured to advantageously facilitate and allow storing of data in a row/column format; a security service that is programmed and configured to facilitates user authentication using and resolution of user rights; a system manager 108 that is programmed and configured to advantageously facilitate the initiation or start of a data correlation inferencing, and a correlation inference engine that is programmed and configured to receive customized requirements for a pre-defined task. The format in which the data is stored, however, is not limited to the above described format, and any other format may be used.

According to an aspect of an exemplary embodiment, a method for collecting, consolidating and processing data, using at least one processor includes validating, using at least one of said at least one processor, a user, receiving, using at least one of said at least one processor, information regarding at least one data stream and at least one acceptance criteria, receiving, using at least one of said at least one processor, a request for correlation inference, and providing, using at least one of said at least one processor, results to the request for correlation inference based on the received information.

According to another exemplary embodiment, the method further includes reading, using at least one of said at least one processor, data from the at least one data stream, and storing, using at least one of said at least one processor, the read data to local transient storage.

According to another exemplary embodiment, the method further includes preparing, using at least one of said at least one processor, results of the correlation inference, and storing, using at least one of said at least one processor, the results in the local transient storage.

According to another exemplary embodiment, the method further includes receiving, using at least one of said at least one processor, queries regarding task status from the user, and providing, using at least one of said at least one processor, status update to the user in response to the received queries.

According to an aspect of another exemplary embodiment, a method for collecting, consolidating and processing data, using at least one processor, includes validating, using at least one of said at least one processor, a user, receiving, using at least one of said at least one processor, data from the user, characterizing; using at least one of said at least one processor, the received data, standardizing using at least one of said at least one processor, the characterized data, receiving, using at least one of said at least one processor, a request for correlation inference, and providing, using at least one of said at least one processor, results to the request for correlation inference based on the received data.

### BRIEF DESCRIPTION OF THE DRAWINGS

The accompanying drawings, which are incorporated in and constitute a part of this specification, exemplify the embodiments of the present disclosure and, together with the description, serve to explain and illustrate principles of the disclosure. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 illustrates an architecture of a system and method for collecting, consolidating and processing data in accordance with the present disclosure;

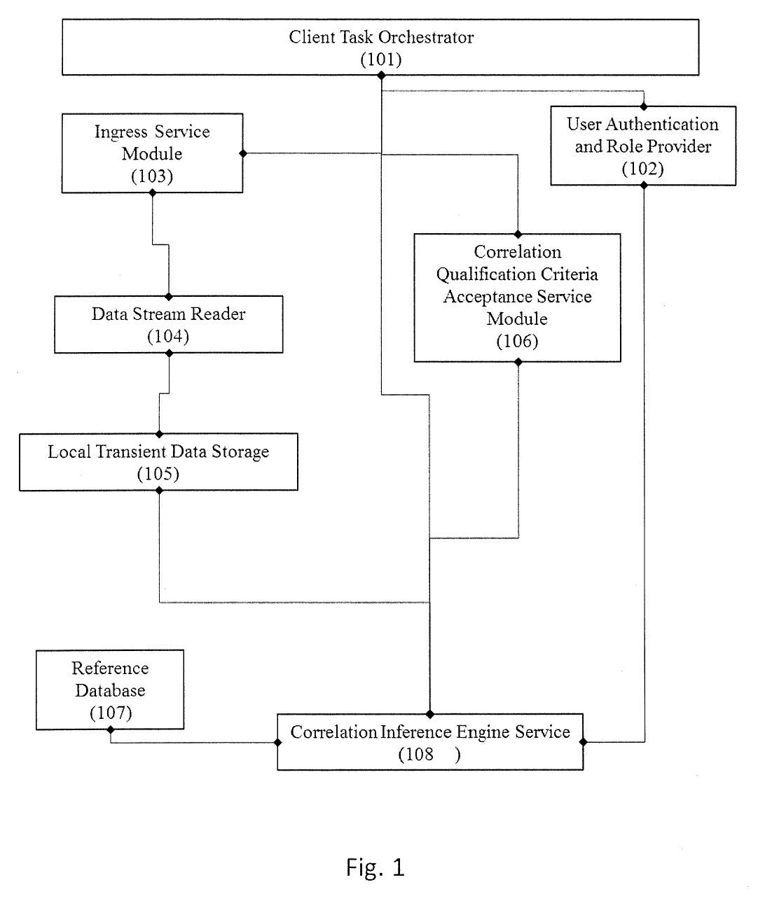

FIG. 2 illustrates a flowchart that represents a method for collecting, consolidating and processing data in accordance with the present disclosure; and

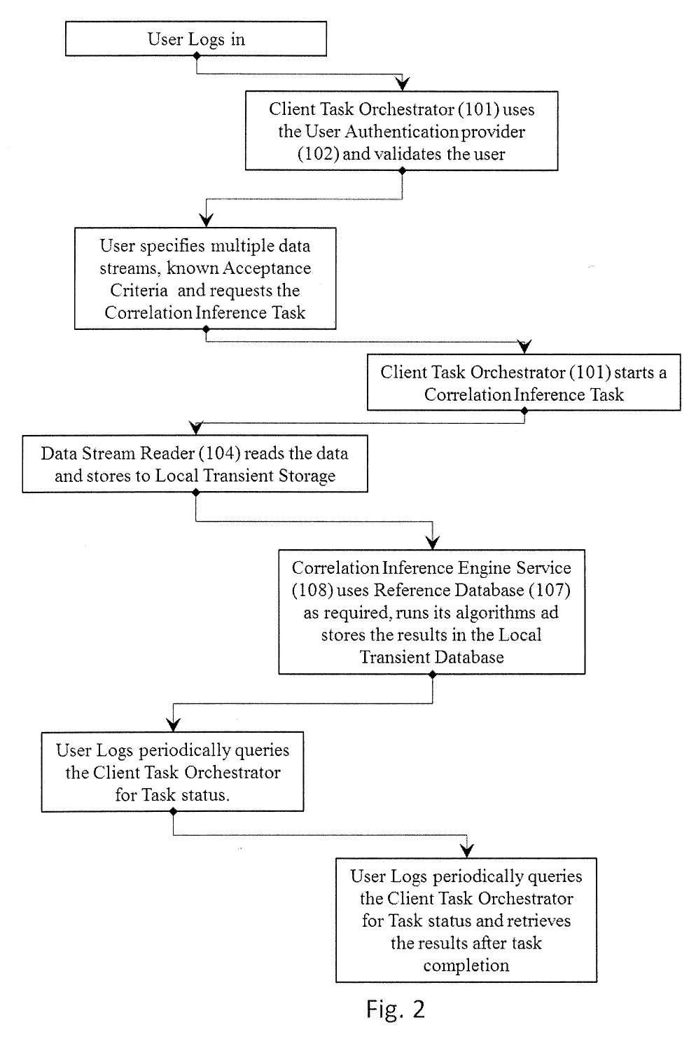

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

The present disclosure is susceptible to various modifications and alternative forms, and some representative embodiments have been shown by way of example in the drawings and will be described in detail herein. It should be understood, however, that the inventive aspects are not limited to the particular forms illustrated in the drawings. Rather, the disclosure is to cover all modifications, equivalents, and alternatives falling within the spirit and scope of the disclosure as defined by the appended claims.

### DETAILED DESCRIPTION

Various examples of the disclosure will now be described. The following description provides specific details for a thorough understanding and enabling description of these examples. One skilled in the relevant art will understand, however, that the disclosure may be practiced without many of these details. Likewise, one skilled in the relevant art will also understand that the disclosure can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the disclosure. Indeed, certain terms may even be emphasized below; however, any terminology intended to be interpreted in any restricted manner will be overtly and specifically defined as such in this Detailed Description section.

While this specification contains many specific implementation details, these should not be construed as limitations on the scope of any disclosure s or of what may be claimed, but rather as descriptions of features specific to particular implementations of particular disclosures. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations may be depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Client Task Orchestrator (101): The system includes a Client Task Orchestrator (101). The Client Task Orchestrator provides a unified contact point for the clients to connect to and consume the facilities provided by the Smart Data Correlation Guesser. In a typical implementation, the Client Task Orchestrator is manifested in the form of a SOAP or REST Web Service running on a secure (https:) web server in internet. In another manifestation, the Client Task Orchestrator is implemented as a Dynamic Linked Library Module (DLL) which a desktop program can load in its process.

User Authentication and Role Provider (102): The system includes a User Authentication and Role Provider (102). The User Authentication and Role Provider authenticates the user identity and assigns the roles defined for the user. After successful authentication, the user can consume the three service modules of Smart Data Correlation Guesser. In a typical implementation, the User Authentication and Role Provider keeps a local database of User IDs, credentials and roles, and uses this local database to validate the users. In another manifestation of the User Authentication and Role Provider, the user credentials are delegated to a third party provider like Microsoft Windows Active Directory running on a Domain Controller or GoogleID/LiveID etc.

Ingress Service Module (103): The system includes an Ingress Service Module (103). Ingress Service Module does the work of reading the data from the data streams specified by a user via the Client Interaction Module. The data streams can be the form of persisted files, or ephemeral or persisted dynamic data streams. The Ingress Service Module can read various formats like XML, TXT, CSV, JSON etc. The Ingress Service Module is not exposed directly to the user. The Client Task Orchestrator (101) delegates tasks of reading from data streams to the Ingress Service Module. In an exemplary implementation, the Ingress Service module is deployed as a Dynamic Linked Library. The ingress service module may further be used to characterize and format the data being received as well.

According to an exemplary embodiment, if a date is being entered by a user, there are numerous different ways in which the date might be input by the user. The Ingress Service Module recognizes what kind of data is being entered by analyzing the input (date being entered in this case), and other related parameters, such as what country the data is being entered from (in this example based on the format of the date being input), thereby not requiring the traditional concept of schema for data input.

Data Stream Reader (104): The system includes a Data Stream Reader. This module can be called by the Ingress Service Module to read the data from the location and store it in the Local Transient Storage. In a typical implementation over the web with a persisted file location, Data Stream reader is implemented using https or sftp protocols. In another implementation, where the data stream is specified as a Query to a remote database, Data Stream Reader is implemented using ODBC/JDBC or ADO.NET.

Local Transient Data Storage (105): The system includes a Local Transient Data Storage. Local Transient Data Storage is not directly available to a user. The Data Stream Reader stores the data in the Local Transient Database for further processing. Any persisted data stored in the Local Transient Data Storage may be purged periodically. In a typical implementation, Local Transient Data Storage is implemented by deploying a Microsoft SQL or MySQL or a comparable database server.

Correlation Qualification Criteria Acceptance Service Module (106): The system includes a Correlation Qualification Criteria Acceptance Service Module (106). The module is not directly accessible to a user. The Client Service Module invokes the Correlation Qualification Criteria Acceptance Service Module when a user requests to add patterns to specify previously known Correlation Qualification Criteria, so that then can be used in future jobs. In a typical implementation, the Correlation Qualification Criteria Acceptance Service Module is manifested in the form of a SOAP or REST Web Service running on a secure (https:) web server in internet. In another manifestation, the Correlation Qualification Criteria Acceptance Service Module is implemented as a Dynamic Linked Library Module (DLL) which a desktop program can load in its process.

Reference Database (107): The system includes a Reference Database (107). The Reference Database is used to persist data that will be used by the Correlation Inference Engine Component Service (108). The data stored in the database contains various ISO Country Codes, ISO Currency Codes, Month Names and Day Names in various languages, Date, Time and Identification document formats. The reference database is updated as required whenever new information is made available via various standards or suggested by clients via Correlation Qualification Criteria Acceptance Service Module (106).

Correlation Inference Engine Component (108): The system includes a Correlation Inference Engine Component (108). Correlation Inference Engine Component is the main component where the disclosure of Smart Data Correlation Guesser is concentrated. Correlation Inference Engine Component is designed, programmed and configured to advantageously facilitate and allow inspecting multiple data streams. Accordingly, the present disclosure provides a system and method for inferring and formulating correlation qualification criteria between the various data streams. The method includes creating a multi-tenant cloud service, wherein a plurality of users from multiple organizations are capable of submitting and specifying data streams via one or multiple physical and/or ephemeral data streams to the multi-tenant cloud service. The multi-tenant cloud service and processes the data independently and independently and/or in an aggregated formats and securely. One implementation of the Correlation Inference Engine Component is as follows:

1) Individual data streams from the local transient storage are parsed and the patterns in the individual data streams are identified and stored in memory or in the local transient storage.

2) The patterns are matched against Reference Database and if matching against the known patterns in the Reference Database, the patterns are attributed with the potential data formats found in the Reference Database.

3) The patterns from various streams are matched against patterns from all different data streams using full and partial match procedures using Regular Expressions, Hashing, Linear substring search, Boyer-Moore and Knuth-Mather-Platt and other string search algorithms. A lookup table of potential correlations is stored in memory or the local transient database.

4) Individual data streams are read again and actual data is compared with the potential correlations table and marked as “Correlating” or “Not Correlating”

5) Once all the data is so inspected, data columns from individual data streams are grouped together with matching ratio and persisted in the local transient database.

### Example

The user wants to find out Correlation between the three data streams A, B and C. Data Streams. For the purpose of describing the disclosures, the data streams in this example contain fictional randomly generated identity data like name and social security number, and other data.

Data Stream A—

| | | | Credit Or | | | |
|---|---|---|---|---|---|---|
| Transaction Date | Transaction Number | Amount | Debit | Account Number | Account Name | Social Sec |
| Nov. 10, 2014 | T2647692483903635 | $3,981.30 | DEBIT | SY186102251017 | GORDON | 921-31-6079 |
| | | | | | Susanna Anne | |
| Apr. 28, 2014 | T7579526567204835 | $139.18 | DEBIT | DU813473828896 | JAY LOWE | 828-51-3260 |
| Sep. 19, 2014 | T1257747728707257 | $98.74 | CREDIT | MC715792747416 | BALAKRISHNA | 063-06-8424 |
| | | | | | BHAT | |

Data Stream B—

| | | Valor da | | | | Código |
|---|---|---|---|---|---|---|
| Encontro | Transação ID | Operação | | Nome do titular da conta | Número da conta | reconciliação |
| 10-novembro-14 | #2647692483903635 | −3981.30 | USD | Susanna Gordon | 565-455270536876693 | ITM240752656 |
| 28-abril-14 | #7579526567204835 | −139.18 | USD | Jay Lowe | 720-641703470525780 | GUZ204763217 |
| 18-setembro-14 | #1257747728707257 | 98.74 | USD | Balakrishna Bhat | 127-517455253462858 | IKG543899104 |

Data Stream C—

| | NUMÉRO DE | | | MONTANT |
|---|---|---|---|---|
| NOM DE | SÉCURITÉ | NUMÉRO DE | | DE LA |
| COMPTE | SOCIALE | COMPTE | TÉLÉPHONE | TRANSACTION |
| GORDON | 921316079 | A/C: | 622-559-3724 | US$ |
| SUSANNA | | SY186102251017 | | (3,981.30) |
| ANNE | | | | |
| LOWE JAY | 828513260 | A/C: | 948-608-9543 | US$ |
| PATRICE | | DU813473828896 | | (139.18) |
| BHAT | 063068424 | A/C: | 212-602-1031 | US$ |
| BALAKRISHNA | | MC715792747416 | | 98.74 |
| VISHWANATH | | | | |

| NOM DE | DATE DE LA | CODE DE LA | |
|---|---|---|---|
| COMPTE | TRANSACTION | RÉCONCILIATIO | REMARQUE |
| GORDON | 2014 Nov. 10 | ITM240752656 | Pjxv hm |
| SUSANNA | | | [2647692483903635] |
| ANNE | | | Cmllfoncir |
| LOWE JAY | 2014 Apr. 28 | GUZ204763217 | Y esfjds |
| PATRICE | | | [7579526567204835] |
| | | | Unhpa |
| BHAT | 2014 Sep. 18 | IKG543899104 | Eeh xef |
| BALAKRISHNA | | | [1257747728707257] |
| VISHWANATH | | | Wocom gcjdu |

Once the three Data Streams are persisted in the local transient storage, the Correlation Inference Engine inspects the data streams and breaks them into patterns.

The codes used for patterns are

A for Alphabetical or diacritic characters defined in Unicode.

N for Numeric Digits defined in Unicode

P for Punctuation Mark

S for Space or blank characters

[symbol]

C for known currency symbols like $, £, €, ¥, [symbol] etc.

Data Stream A, Column 1 (Transaction Date) is attributed with a pattern as follows:

Value 1: 11/10/2014 is converted to the patters 2N,1P,2N,1P,4N

Value 2: 4/28/2014 is converted to the patters 1N,1P,2N,1P,4N

Value 3: 9/18/2014 is converted to the patters 1N,1P,2N,1P,4N

The same procedure is executed on all the columns in all the data streams and the data values are attributed to corresponding patterns.

The reference database contains the patterns 2N,1P,2N,1P,4N and 1N,1P,2N,1P,4N as potentially corresponding to data having DATE.

Correlation Inference Engine runs through all the data values in Column-1 and tries to parse the data as a valid date. It stores the information about every data values and potential date formats. In this example,

Value 1—Possible date formats: dd/mm/yyyy and mm/dd/yyyy.

Value 2—Possible date formats: mm/dd/yyyy

Value 3—Possible date formats: mm/dd/yyy

Considering the common date format, Correlation Inference Engine attributes the Values in Column 1 as belonging to mm/dd/yyyy format and stores the information in the local transient storage.

Similarly, Correlation Inference Engine inspects and attempts to find data types of all data values in all data streams, attributes them and stores the information in local transient storage.

In the next step, the Correlation Inference Engine tries to match patterns between data streams by using the data type information attributed to the values and also tries to match partial patterns within the different columns of all data streams and persists the findings in the local transient storage.

In the next step, the Correlation Inference Engine attempts to validate the findings by actually going through all the potentially matching data and tries to match it in the corresponding potential matching data stream and persists the success/failure for every match operation.

At this point the results are present in the persisted local transient storage. A user can call the Client Task Orchestrator to retrieve the results of the Correlation Inference.

One workflow for a user is as follows:

User logs in with appropriate credentials.

Uploads or specifies the data stream and invokes a Correlation Inference Task. User receives a Task Id.

User periodically queries for the status of the task by specifying the Task Id.

User can retrieve the result once the task is completed.

In another workflow:

User logs in with appropriate credentials.

Uploads or specifies the data stream and invokes a Correlation Inference Task. User receives a Task Id.

Client Task Orchestrator informs the user of the task completion status by utilizing a communication mechanism like email, text message to a mobile phone etc.

User can retrieve the result once the task is completed.

In optional steps, user, prior to or subsequent to the Correlation Interface Task completion send the known patterns and possible correlation hints to the Client Task Orchestrator. Client Task Orchestrator delegates the information to Correlation Qualification Criteria Acceptance Service Module and subsequently, stored in the local transient storage.

Upon the completion of the task, the local transient storage is purged of all the user data. The correlation patterns inferred during the run are stored for further reference, essentially making the system a self-improving system.

It should also be noted that the disclosure is illustrated and discussed herein as having a plurality of modules which perform particular functions. It should be understood that these modules are merely schematically illustrated based on their function for clarity purposes only, and do not necessary represent specific hardware or software. In this regard, these modules may be hardware and/or software implemented to substantially perform the particular functions discussed. Moreover, the modules may be combined together within the disclosure, or divided into additional modules based on the particular function desired. Thus, the disclosure should not be construed to limit the present disclosure, but merely be understood to illustrate one example implementation thereof.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A method for collecting, consolidating and processing data, the method comprising:
creating a multi-tenant cloud service, wherein a plurality of users from multiple organizations are capable of submitting data via one or multiple physical and/or ephemeral data streams to the multi-tenant cloud service, the multi-tenant cloud service processes the data independently and/or in an aggregated formats;
implementing an ingress system, the ingress system capable of allowing the users to submit the data in various formats and types;
automatically recognizing the format and type of the data;
creating an ingress point where the user can specify previously known correlation patterns;
providing correlation inferences based in the user inputs; and
allowing users to retrieve the results of the correlation inference.

2. The method of claim 1, wherein the plurality of users are capable of being uploading and processing data in the multi-tenant cloud service independently.

3. The method of claim 1, wherein the data can be submitted using various data formats, persisted and/r ephemeral.

4. The method of claim 1, wherein all organizations are being capable of uploading data using more than one format.

5. A system for collecting, consolidating and processing data, the system comprising:
a database service that is programmed and configured to advantageously facilitate and allow storing of data in a row/column format; a security service that is programmed and configured to facilitates user authentication using and resolution of user rights; a system manager that is programmed and configured to advantageously facilitate the initiation or start of a data correlation inferencing; and
a correlation inference engine that is programmed and configured to receive customized requirements for a pre-defined task.

6. A method for collecting, consolidating and processing data, using at least one processor, the method comprising:
validating, using at least one of said at least one processor, a user;
receiving, using at least one of said at least one processor, information regarding at least one data stream and at least one acceptance criteria;
receiving, using at least one of said at least one processor, a request for correlation inference; and
providing, using at least one of said at least one processor, results to the request for correlation inference based on the received information.

7. The method of claim 6, further comprising:
reading, using at least one of said at least one processor, data from the at least one data stream; and
storing, using at least one of said at least one processor, the read data to local transient storage.

8. The method of claim 6, further comprising:
preparing, using at least one of said at least one processor, results of the correlation inference; and
storing, using at least one of said at least one processor, the results in the local transient storage.

9. The method of claim 6, further comprising:
receiving, using at least one of said at least one processor, queries regarding task status from the user; and
providing, using at least one of said at least one processor, status update to the user in response to the received queries.

10. A method for collecting, consolidating and processing data, using at least one processor, the method comprising: Identifying the known drug as a potential treatment for the first phenotype, when the first phenotype and the second phenotype share a substantial similarity in exposome space
validating, using at least one of said at least one processor, a user;
receiving, using at least one of said at least one processor, data from the user;
characterizing; using at least one of said at least one processor, the received data;
standardizing using at least one of said at least one processor, the characterized data;
receiving, using at least one of said at least one processor, a request for correlation inference; and
providing, using at least one of said at least one processor, results to the request for correlation inference based on the received data.
